(19) United States
(12) Patent Application Publication
(10) Pub. No.: US 2006/0077866 A1
(43) Pub. Date: Apr. 13, 2006

(54) Optical scanning device

(76) Inventors: Michael Adrianus Henricus Van Der Aa, Eindhoven (NL); Gerardus Lucien Mathildus Jansen, Eindhoven (NL); Gerard Johannes Pieter Nijsse, Eindhoven (NL); Johannes Joseph Hubertina Barbara Schleipen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/540,707

(22) PCT Filed: Dec. 18, 2003
(86) PCT No.: PCT/IB03/06138

§ 371 Date: Jun. 24, 2005

(30) Foreign Application Priority Data
Dec. 30, 2002 (EP) 02080578.4

(51) Int. Cl. G11B 7/00

(52) U.S. Cl. 369/125

(57) ABSTRACT

An optical scanning device for scanning tracks of an optical record carrier (OD) using a radiation beam, the device including an optical head (16), defining an optical axis (OA), for converging the radiation beam to a spot when scanning the record carrier; and a rotary arm (2) for moving the optical head across the record carrier. The device further comprises a rotatably mounted diffraction grating (8) for generating satellite beams for performing multi-spot tracking. Rotation of the grating is arranged to move the satellite beams, relative to the optical axis of the optical head, in correspondence with rotation of the rotary arm.

This invention relates to an optical scanning device, and in particular to an optical scanning device comprising a rotary arm for scanning an optical head across an optical record carrier.

The rotary arm system is known for electromechanical adjustment of a read/write head. A rotary arm scanning mechanism is widely used in magnetic disc recording/reproducing apparatus, commonly known as hard disc drives, for scanning magnetic discs. The use of a rotary arm has also been considered for optical disc recording/reproducing apparatus, for scanning optical or magneto-optical discs. A rotary arm provides a simpler mechanism with a reduced number of parts compared to a 2-stage sledge mechanism, which is the most commonly used scanning mechanism in optical disc systems.

In known optical scanning devices in which a rotary arm scanning mechanism is used, the optical components, including the laser and detector system, are located on the moving rotary arm. In such a system all the control and information signals for the laser and the detector system have to be transferred over a connection foil to and from the rotary arm system. In the case of a Small Form Factor Optical (SFFO) device, due to the high speeds and the required noise immunity, even the electronics for driving the laser and processing the detector signals may need to be located on the moving arm. This would result in a thermal problem with heat dissipation of the laser and its associated electronics (driver), a dynamical problem due to the relatively heavy weight of the optical and electrical components, and an interconnection problem due to the large amount of electrical connections to the laser circuitry and the detection circuitry.

WO-A-9809285 describes an optical scanning device in which the laser light is transported to the optical head using optical fibers. A problem with this approach is the alignment accuracy of the coupling lenses with respect to the optical fiber. Another problem is the amount of coupling losses, when the signals are coupled in and out of the fiber.

Another known type of scanning device incorporating a rotary arm includes a periscope. In such a system a set of two mirrors located exactly around the rotation axis of the rotary arm will direct the beam to and from the arm. One mirror is fixed to the base plate; the other mirror is fixed to the rotary arm.

U.S. Pat. No. 5,541,908 describes an optical scanning system comprising a radial arm and a separately mounted optical unit including a radiation source and a detection system. The radial arm includes a tracking mirror, which is actuated by a one spot push-pull tracking error signal. As is known in the art, a one spot tracking error signal can be of a poor quality in the case of misalignment of the detector with the spot. However, if the preferred three spots tracking were used, rotation of the arm would cause movement of the sidebeam spots across the tracks on the disc, which makes it impossible to generate a tracking error signal correctly.

In accordance with the present invention there is provided an optical scanning device for scanning an optical record carrier using a radiation beam, the device including:
an optical head, defining an optical axis, for converging the radiation beam to a spot when scanning the record carrier; and
a rotary arm for moving the optical head across the record carrier,
characterized in that the device further comprises an optical arrangement for generating satellite beams for performing multi-spot tracking, and in that the optical arrangement is arranged to move the satellite beams, relative to said optical axis of the optical head, in correspondence with rotation of the rotary arm.

By so moving the satellite beams, the satellite beam spots can be arranged to properly follow tracks on the disc, irrespective of the rotary position of the rotary arm.

Further features and advantages of the invention will become apparent from the following description of preferred embodiments of the invention, given by way of example only and with reference to the accompanying drawings, in which:

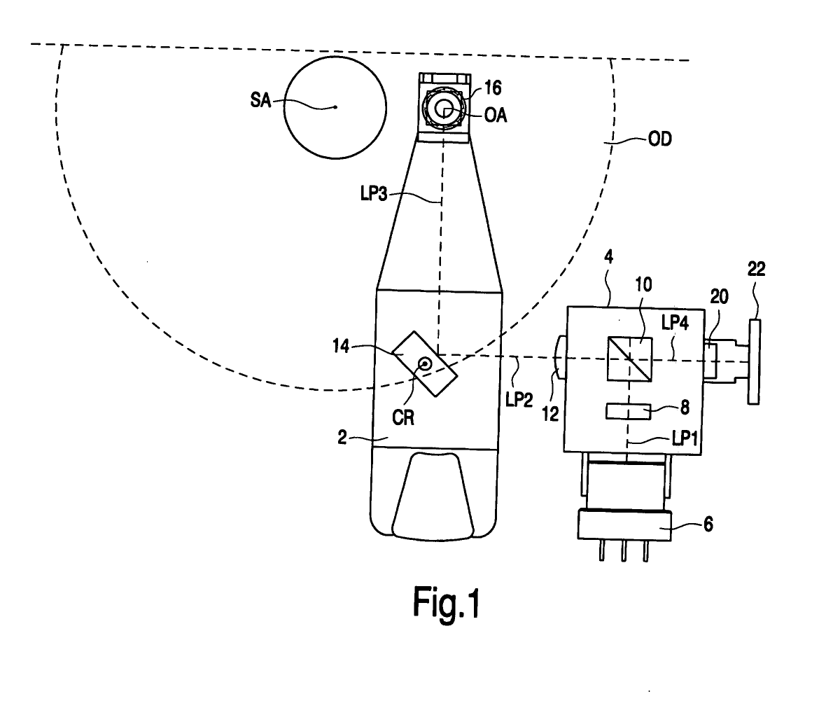

FIG. 1 shows a plan view of components of an optical scanning device, arranged in accordance with an embodiment of the invention;

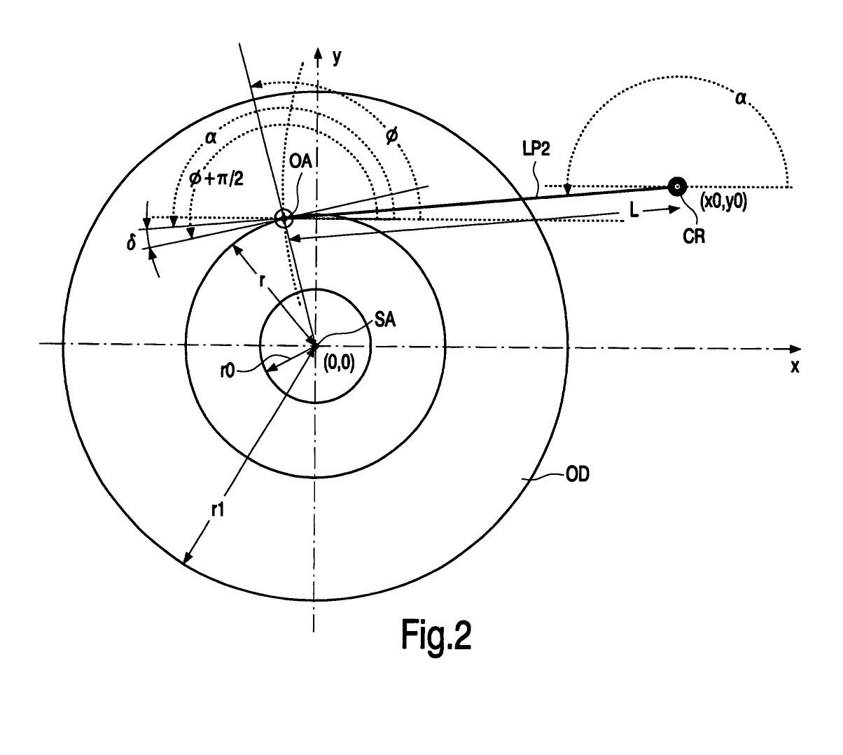

FIG. 2 is a schematic illustration of parameters of the device shown in FIG. 1;

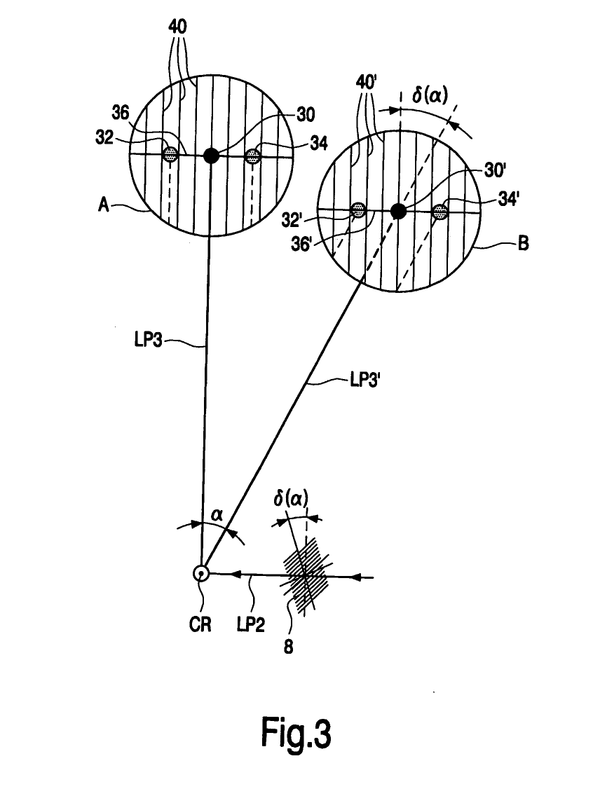

FIG. 3 is a schematic illustration of the positioning of satellite spots in accordance with an embodiment of the invention when a rotary arm is rotated between different positions;

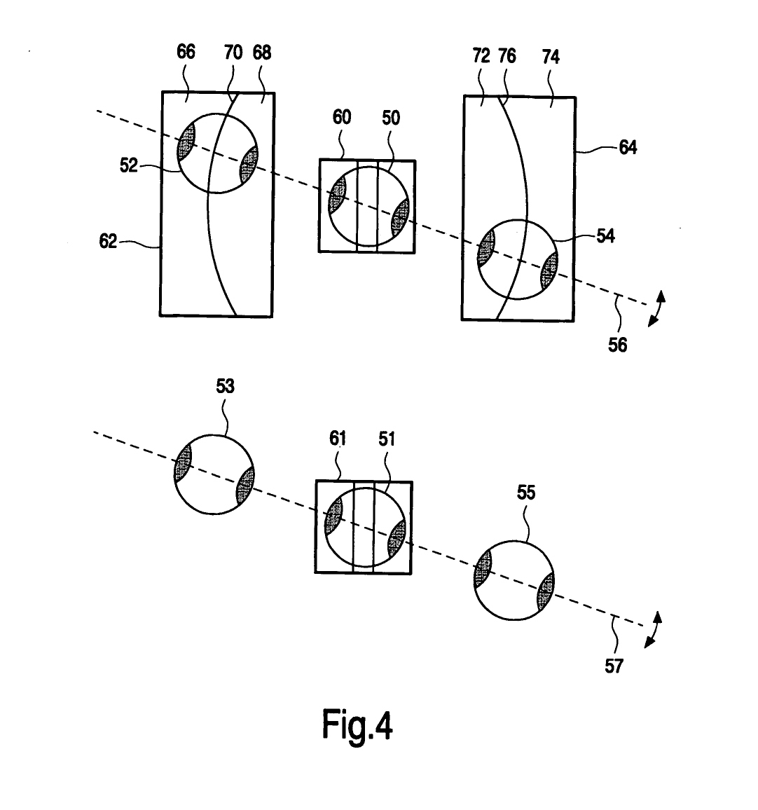

FIG. 4 is a plan view of a detector array arranged in accordance with an embodiment of the invention; and

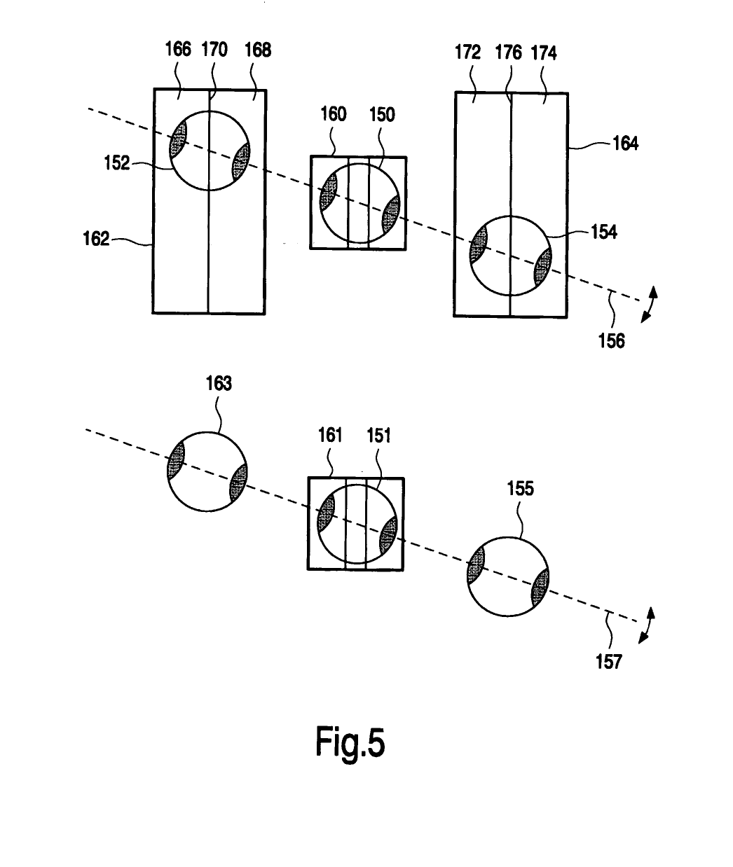

FIG. 5 is a plan view of a detector array arranged in accordance with a further embodiment of the invention.

Referring now to FIG. 1, an optical scanning device in accordance with one embodiment of the invention includes a rotary arm 2 and a separate, fixedly mounted, optical unit 4. The optical unit 4 includes a radiation source 6, operating at a predetermined frequency, for example a frequency in the region of 400 to 420 nm, projecting a radiation beam along a first light path LP1 towards a beam splitter 10. A rotatably-mounted three spot diffraction grating 8 is mounted along the first light path LP1 between the radiation source 6 and the beam splitter 10. Note that, hereafter, when reference is made to “the radiation beam”, this generally includes the main radiation beam and each satellite beam, which are transmitted along similar paths within the optical scanning device and through common optical components. The diffraction grating 8 is a linear diffraction grating, arranged to separate the light beam into a main, zeroth order beam and first and second first order satellite beams to each side thereof. The diffraction grating 8 is mounted for rotation about a rotation axis coincident with the center of the first light path LP1. The beam splitter 10 is arranged to reflect the radiation beam along a second light path LP2, towards a collimator lens 12 which substantially collimates the beam to form a beam consisting of substantially parallel rays of radiation.

A rotary mirror 14 is mounted on the rotary arm 2 adjacent the collimator lens 12 on the optical unit 4 to receive the radiation beam and direct it along a third light path LP3 towards an optical head 16 at the far end of the rotary arm 2. In this embodiment, the rotary mirror 14 shares an axis of rotation CR with the rotary arm, however in other embodiments the axes of rotation may be displaced with respect to each other. The angle of rotation of the rotary mirror 14 is controlled in correspondence with rotation of the rotary arm 2; generally, the amount of rotation of the rotary mirror 14 will be half of the amount of rotation of the rotary arm 2. The optical head 16 includes a folding mirror, arranged at 45° to the third light path LP3, to direct the radiation beam onto an objective lens. The objective lens and the folding mirror are mounted in a lens holder. This lens holder is suspended on two parallel flexures, which allow the lens holder to move in an axial (focus) direction. A drive coil is located at the front of the lens holder. This coil generates axial forces in order to bring the lens to the proper focus. The objective lens has an optical axis OA, along which the main radiation beam is transmitted by the folding mirror, to form a spot focused, on an information layer of an optical disc OD mounted in the optical scanning device, at a location along the optical axis OA. The satellite beams, meanwhile, pass through the objective lens to form focused spots on the information layer to each side of the optical axis OA. The three focused spots are arranged along a line of alignment having a rotational position about the optical axis OA which is determined by the rotational state of the diffraction grating 8. The objective lens in the optical head 16 is mounted within an axial actuator, which is driven by a focus control signal to maintain each of the main and satellite beam spots in correct focus on the optical disc OD.

The optical disc OD may be one of a number of different types, including a read-only type, a recordable (write-once) type and a re-writable type. The optical disc OD is mounted on a spindle in the optical scanning device to rotate about a spinning axis SA during scanning of the optical disc OD. The optical disc includes data tracks in the form of a pit train and/or at least one of the lands and grooves of a land/groove structure, which are arranged on the disc in a spiral or circular arrangement concentric with the spinning axis SA. The optical disc OD may include one or more information layers; in the case of a multi-layer disc, the information layers are located at different depths within the optical disc OD, and the scanning device includes a spherical aberration compensation system for compensating the different amounts of spherical aberration generated when scanning the different information layers.

After scanning of an information layer of the optical disc OD, the radiation beam is reflected back through the optical head 16, along the third and second light paths LP3, LP2, and in the optical unit 4 is transmitted through the beam splitter 10 to pass along a fourth light path LP4 towards a detector array 22. The detector array 22 includes detector elements, which will be described in greater detail below, which produce a main information signal, a focus error signal and a tracking error signal. The focus error signal is used as the focus control signal to drive the focus actuator in the optical head 16, whilst the tracking error signal is arranged to control movement of the rotary mirror 14, or the rotary arm 2, as will be described in greater detail below. A spot-size focusing type optical element 20, associated with a novel detector array 22, to be described in further detail below, is arranged along the fourth light path LP4, to provide a main radiation beam to the detector array, whereby to conduct spot-size focus error detection.

The rotary mirror 14 and the rotatable grating 8 may be mounted on a rotational bearing consisting of two ball elements on one part, which move in a two bearing shale mounted on the other part. The actuation of the rotary mirror 14 and the rotatable grating 8 can be performed using a Lorenz type actuator with a magnet on one part and a coil fixed to an opposing part.

The rotary arm 2 has a bearing system, which consists of two ball elements. One ball element is located on one part; the other ball is located on the other part. The ball elements are allowed to rotate in a slightly oversized bearing shale. The actuation system for the rotary arm 2 includes a coil at one end of the arm located in a magnetic field, such that one side of the coil is in a vertical upwards field and the other side of the coil is in a vertical downwards field. A current through the coil will generate Lorenz forces, which rotate the arm in the desired direction.

A two-stage tracking control method is applied where one of the rotary arm 2 or the rotary mirror 14 is controlled via a separate sensor signal from a detector on the rotary arm or from a signal reflected from the optical media, and the other of the rotary arm 2 or the rotary mirror 14 is controlled via the detected tracking error signal generated in the detector array 22.

The separate sensor signal can be provided using two forward sense photodiodes positioned on the rotary arm at both sides of the radiation beam. Whenever the beam is not positioned correctly, one of the two photodiodes will collect more light than the other, providing a well defined control signal. Alternatively, the separate sensor signal can be generated by sampling a blank part on the media. A shift of the beam in the pupil of the objective lens will generate a shift in the center of the reflected beam. This shift can be detected via a differential detection on the detector array 22.

There are two possible actuator control arrangements possible for a proper cooperation of the rotary mirror 14 with the rotating arm. In one embodiment the mirror is actuated as a slave, the rotary arm is actuated as a master. The rotary mirror 14 is driven by the separate sensor signal as generated by one of the above mentioned methods. The rotary arm 2 is driven by the tracking error signal generated in the detector array 22. The bandwidth of the arm actuator could be up to 2-3 kHz. The bandwidth of the mirror actuator is preferable approximately a factor 10 lower, say 200-300 Hz.

In a second actuator control arrangement the rotary arm is actuated as a slave, the mirror is actuated as a master. The rotary mirror 14 is driven by the tracking error signal generated in the detector array 22. The rotary arm 2 is driven by the separate sensor signal as generated by one of the above mentioned methods. An advantage of this type of loop is that it can utilize the high bandwidth, which is possible with a small tracking mirror. The bandwidth of total system is not limited by the larger arm construction. The bandwidth of the mirror actuator can be some 5-6 kHz, the arm actuator bandwidth some 300-400 Hz.

FIG. 2 is a schematic illustration of parameters of the arrangement of the optical head 16 on the rotary arm 2 with respect to the disc OD, and the direction of tracks on the disc OD. An arbitrary x-y coordinate system is chosen with the disc positioned with the center of the tracks, SA, at coordinates (0,0). The rotary arm 2 has a length L between the rotation axis CR and the optical axis OA of the optical head 16. The rotation axis CR is located at coordinates (x₀,y₀). The angle of the rotary arm with respect to the x-axis is denoted α. At a certain angle α the laser is focussed at point OA on the disc. OA is described by a radius r and an azimuthal angle φ (with respect to the positive x-axis). The angle of the tracks at point OA with respect to the positive x-axis is therefore given by φ+π/2. For a given arm length L, φ and r can be expressed as function of the rotary arm (angular) position a. Namely, φ(α) and r(α) can be written as:

$$\begin{matrix}r ( α ) = \sqrt{{( {x}_{0} + L \cdot cos ( α ) )}^{2} + {( {y}_{0} + L \cdot sin ( α ) )}^{2}} & ( 1 ) \\ ϕ ( α ) = arctan ( \frac{{y}_{0} + L \cdot sin ( α )}{{x}_{0} + L \cdot cos ( α )} ) & ( 2 ) \\ δ ( α ) = ϕ ( α ) - α + π / 2 & ( 3 )\end{matrix}$$

As the arm rotates to move the optical head 16 across the disc the angles φ and α change, and consequently the angle δ, the orientation of the rotary arm with respect to the track direction, changes. The orientation of the rotary arm is equal to the orientation of an arbitrary line, passing through the optical axis OA and aligned parallel with the rotary arm, on the optical head 16. By rotation of the grating 8 by an amount equal to that angle (δ) the position of the spots on the disc with respect to the arbitrary line on the optical head 16 changes correspondingly and the alignment of the spots on the disc with respect to the track direction is maintained.

FIG. 3 illustrates the way in which the alignment of the beam spots on the optical disc OD is controlled during rotation of the rotary arm 2 by corresponding rotation of the diffraction grating 8. FIG. 3 shows the positioning of the spots in first and second scanning areas A, B, each shown in magnified plan view in FIG. 3, of the optical disc OD, when the rotary arm 2 is rotated between a first position LP3 and a second position LP3′, which are separated by an angle of rotation a about the center of rotation CR. In the first position, for scanning in the first scanning area A, the main spot 30 follows a path centered on one of the data track sections 40 of the optical disc OD. Meanwhile, the satellite beams 32, 34 each follow a path halfway between two respective adjacent track sections 40. The path followed by the satellite beam spots 32, 34 is thus laterally separated from the path followed by the main beam spot 30 by ±(N+½)tp, where N is an integer (0, 1, 2 . . . ) and where tp is the track pitch. The rotational position of the grating 8 is controlled such that the three spots 30, 32, 34 are arranged along a line of alignment 36, which is perpendicular to the direction of the track sections 40 in the scanning area A.

In the second rotary position of the rotary arm 2, for scanning in the second scanning area B, the track sections 40′ are arranged at an angle with respect to the track sections 40 in the first scanning area A. The relative angular separation between the first data track sections 40 and the second data track sections 40′ is a function of the relative positioning of the spinning axis SA of the disc OD and the center of rotation CR of the rotary arm 2, along with the length of the rotary arm 2 between the center of rotation CR and the optical axis OA of the optical head 16.

In the second rotary position, the diffraction grating 8 is rotated, with respect to its position in the first position of the rotary arm, by the angle δ(α), which produces a corresponding and equal rotation of the satellite spots 32′, 34′ with respect to the optical axis OA of the optical head 16 of δ(α). The amount of rotation of the satellite spots 32′, 34′ is controlled in correspondence with rotation of the rotary arm to ensure that the line 36′ along which all three spots 30′, 32′, 34′ are aligned remains perpendicular to the data track sections 40′. The amount of rotation takes into account firstly the angle of rotation α of the rotary arm 2 and secondly the angular separation of the data track sections between the first scanning position and the second scanning position, according to the relationships given in equations (2) and (3) above. Thus, δ(α) varies in relation to a by an amount which takes into account the amount of angular separation between the track sections 40 in the first scanning position and the track sections 40′ in the second scanning position on the optical disc.

FIG. 4 illustrates a detector array arrangement suitable for detecting a main information signal, a spot-size focus error signal and a three spots push pull tracking error signal from two main beam spots 50, 51 and a set of satellite beam spots 52, 54 at the detector. One set of three beam spots 50, 52, 54 are aligned along a line 56 which rotates about the main beam spot 50 in correspondence with the rotation of the lines of alignment 36, 36′, along which the scanning beam spots are arranged, with respect to the optical head 16. A further set of three beam spots 51, 53, 55 are aligned along a similar line 57.

Conventional main spot detectors 60, 61, each including for example a three segment detector arrangement for e.g. spot-size detection, as known in the art, is used to detect information and control signals from the main beam spots 50, 51, including a main data signal, a spot-size focus error signal and a component of the three spot push pull tracking error signal, as is known in the art. Two novel satellite beam spot detectors 62, 64 are arranged to each side of one of the main beam spot detectors 60. The satellite beam spot detectors each include two detector segments 66, 68; 72, 74 separated by a separating line 70; 76 which is arranged to bisect each satellite beam spot 52; 54 irrespective of the angular position of the line of alignment 56. Thus, each separating line 70; 76 is curved in a manner such that the center of the satellite beam spot coincides with a point along the separating line 70, 76 as the satellite beam spots 52, 54 are rotated at the main beam spot 50 due to rotation of the diffraction grating 8 during rotation of the rotary arm 2. The push pull tracking error signals from each of the three detectors 60, 62, 64 are combined in a known manner, to form a combined three spot push pull tracking error signal, which is well compensated for misalignment between the detector array and the beam spots.

FIG. 5 illustrates an alternative detector array arrangement suitable for detecting a main information signal, a spot-size focus error signal and a three spots push pull tracking error signal. The arrangement is similar to that shown in FIG. 4, and similar features are referenced with the same reference numerals, except incremented by 100; the description thereof above should be taken to apply here also. In this embodiment, the separating lines 170, 176 are straight rather than curved, which increases ease of manufacture. Even in this embodiment, the separating lines 170, 176 are generally aligned with a direction of movement of the satellite detector spots when the rotary arm is rotated Providing the angle of rotation of the rotary arm is not too large, this arrangement of detector elements can provide a reliable tracking error signal, as the movement of the spots to each side of the separating lines as the satellite spots rotate is symmetrical and is therefore compensated in the push-pull signal processing method.

The above embodiments are to be understood as illustrative examples of the invention. Further embodiments of the invention are envisaged. For example, whilst the above-described embodiment uses a spot-size focus error detection method, alternatively a Foucault type focus error detection method may alternatively be used in combination with a three spot tracking error detection method.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning tracks of an optical record carrier using a radiation beam, the device including:
an optical head, defining an optical axis, for converging the radiation beam to a spot when scanning the record carrier; and
a rotary arm for moving the optical head across the record carrier,
characterized in that the device further comprises an optical arrangement for generating satellite beams for performing multi-spot tracking, and in that the optical arrangement is arranged to move the satellite beams, relative to said optical axis of the optical head, in correspondence with rotation of the rotary arm.

2. An optical scanning device according to claim 1, wherein the optical arrangement is arranged to rotate the satellite beams, relative to said optical axis of the optical head, in correspondence with rotation of the rotary arm.

3. An optical scanning device according to claim 1, wherein the optical arrangement comprises means for generating the satellite beams, and said means are rotatable to provide said movement of the satellite beams.

4. An optical scanning device according to claim 3, wherein said means comprise a diffraction grating.

5. An optical scanning device according to claim 1, wherein said device comprises a radiation source mounted separately from said rotary arm.

6. An optical scanning device according to claim 1, wherein said device comprises a detector array comprising satellite detector elements arranged to detect satellite detector spots in a range of rotational positions about a main detector spot.

7. An optical scanning device according to claim 6, wherein said satellite detector elements comprise two elements separated by a separation line which is generally aligned with a direction of movement of the satellite detector spots when the rotary arm is rotated.

8. An optical scanning device according to claim 6, wherein said device comprises spot-size type or Foucault type optical element associated with said detector array.

9. An optical scanning device according to claim 1, wherein the optical arrangement is arranged to move the satellite beams between a first positioning, in a first rotary position of the arm and a second positioning, in a second rotary position of the arm, so as to take into account rotary movement of the arm relative to the record carrier.

10. An optical scanning device according to claim 1, wherein the record carrier is in the form of an optical disc and the optical arrangement is arranged to move the satellite beams between a first positioning, in a first rotary position of the arm and a second positioning, in a second rotary position of the arm, so as to take into account angular separation of the tracks, relative to each other, at the optical head in the first and second positions of the rotary arm.

11. An optical scanning device according to claim 1, wherein the optical arrangement is arranged to position satellite beam spots on the record carrier along a line which is substantially perpendicular to the direction of the tracks.
